(19) United States
(12) Patent Application Publication
(10) Pub. No.: US 2010/0279660 A1
(43) Pub. Date: Nov. 4, 2010

(54) SYSTEM AND METHOD FOR VISUAL VOICEMAIL

(75) Inventors: Eskil G. Ahlin, Veberod (SE); Chris Horn, Wokingham (GB)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 12/679,988

(22) PCT Filed: Aug. 25, 2008
(86) PCT No.: PCT/IB2008/002199

§ 371 Date: Jun. 29, 2010

Related U.S. Application Data
(60) Provisional application No. 60/976,219, filed on Sep. 28, 2007.

(51) Int. Cl. H04W 4/12

(52) U.S. Cl. 455/412.2; 455/413

(57) ABSTRACT

To enhance user interaction with voicemail messages and information that may be displayed for the voicemail messages, the present disclosure describes an improved approach to delivering voicemail messages to an electronic device, such as a mobile telephone. In one embodiment, the voicemail message is packaged into a multimedia message that is transmitted to the mobile telephone. The multimedia message may contain information that identifies the multimedia message as containing voicemail message data, such as an extension header and/or a scripted subject field.

### RELATED APPLICATION DATA

This application claims the benefit of U.S. Provisional Patent Application No. 60/976,219, filed Sep. 28, 2007, the disclosure of which is herein incorporated by reference in its entirety.

### TECHNICAL FIELD OF THE INVENTION

The technology of the present disclosure relates generally to voicemail services and, more particularly, to a system and method that formats a voicemail message for delivery to an electronic device so that the electronic device may visually present information related to the voicemail message.

### BACKGROUND

Mobile and/or wireless electronic devices are becoming increasingly popular. For example, mobile telephones, portable media players and portable gaming devices are now in wide-spread use.

If a user of a mobile telephone does not answer a call, the call is typically transferred to a voicemail system that allows the calling party to record a voicemail message for the user of the mobile telephone. In conventional voicemail systems, the user of the mobile telephone may retrieve voicemail messages that are recorded by the voicemail system by placing a call to the voicemail system and listening to the messages in the sequence in which the messages were recorded. Some mobile telephones may display an icon to the user that a voicemail message is waiting for retrieval.

To present more information about voicemail messages to the user and more interactive features regarding the playback and management of voicemail messages, visual voicemail has been proposed. Visual voicemail may present voicemail messages in list format. For instance, a description of each voicemail message may be displayed on a display. The description may include the time and date of the voicemail message and the person leaving the voicemail message (e.g., an identifier such as the telephone number of the calling device or a user name associated with the calling device). The messages may be retrieved by selecting a particular entry, regardless of the order in which the messages were left. Also, the user may sort and manage the messages.

One such visual voicemail system has been developed by Comverse of Wakefield, Mass., USA, which is available on some devices sold under the designation BLACKBERRY by Research in Motion of Waterloo, Ontario, Canada. Also, devices sold under the designation IPHONE by Apple Inc. of Cupertino, Calif., USA include a visual voicemail feature. But these approaches rely on a visual voicemail software client that is embedded in the user's device. Hence, legacy devices without the client, and/or without the capability of executing the client, will not be able to support visual voicemail features.

### SUMMARY

To enhance user interaction with voicemail messages and information that may be displayed for the voicemail messages, the present disclosure describes an improved approach to delivering voicemail messages to an electronic device, such as a mobile telephone. In one embodiment, the mobile telephone does not include a visual voicemail client, but relies on other platforms to emulate various visual voicemail features such as, but not limited to, displaying messages in a list, sorting messages, and non-sequential message access. Features and operation of the disclosed visual voicemail technique are described in the context of delivering a voicemail message to a user's device and processing the associated data with the device. But other types of payload, such as video messages, may be delivered and processed in the same manner or in a similar manner.

In one embodiment, the voicemail message is packaged into a multimedia message that is transmitted to the mobile telephone. So that the user may be visually presented with information about the voicemail message, a subject field of the corresponding multimedia message may indicate the nature of the multimedia message.

Also, the mobile telephone may include functionality to be a voicemail aware device so that the multimedia messages containing voicemail messages may be placed in a voicemail message folder, apart from other multimedia messages and other files. In this manner, the voicemail message folder serves as a voicemail message “inbox” and the items in the folder may be displayed to the user. The folder also provides a convenient user interface from which the user may access and manage voicemail messages. Managing the messages may include, for example, functions such as selecting a message for playback, scanning or scrolling through messages, forwarding a message, deleting a message, moving a message to a subfolder, replying to a message, and placing a call to the person who left the message (e.g., returning the call), etc. Selectable menu options may be displayed in association with the displayed voicemail messages. To implement this functionality, the multimedia message containing the voicemail message may include data that may be used to distinguish the message from other messages. For instance, an extension header may be inserted into the body of the multimedia message to indicate that the multimedia message contains voicemail message data. In another embodiment, an existing, standardized multimedia message header may be used to embed the indication in the multimedia message. The embedded indication that the multimedia message contains a voicemail message also may be used to invoke other actions by the mobile telephone. For instance, upon receipt of such a message, the mobile telephone may generate a specific indication to the user, such as one or more of generating an audio output (e.g., playing a ring tone), displaying an icon or other graphic, vibrating or the like. Other actions based on the embedded information may be possible.

As will be appreciated, the disclosure describes an interoperable visual voicemail message that does not rely on a visual voicemail software client.

According to one aspect of the disclosure, a method of preparing a voicemail message for delivery to an electronic device includes storing audio data from a user of a calling device as part of a multimedia message; and adding identification information to the multimedia message so as to identify the multimedia message as containing voicemail message data, wherein a first portion of the added identification information is content of a subject field of the multimedia message and a second portion of the added identification information is embedded into the multimedia message as one of an extension header or a standardized header.

According to one embodiment of the method, the subject field is scripted so that when the content of the subject field is displayed to a user of the electronic device the user understands that voicemail message data is associated with the displayed content.

According to one embodiment of the method, the multimedia message is transmitted to a multimedia messaging service center for delivery to the electronic device.

According to one embodiment, the method further includes adding the identification information to a multimedia message notification that is associated with the multimedia message.

According to another aspect of the disclosure, a voicemail system that prepares a voicemail message for delivery to an electronic device includes a visual voicemail support function that stores audio data from a user of a calling device as part of a multimedia message and adds identification information to the multimedia message so as to identify the multimedia message as containing voicemail message data, wherein a first portion of the added identification information is content of a subject field of the multimedia message and a second portion of the added identification information is embedded into the multimedia message as one of an extension header or a standardized header.

According to one embodiment of the voicemail system, the subject field is scripted so that when the content of the subject field is displayed to a user of the electronic device the user understands that voicemail message data is associated with the displayed content.

According to one embodiment of the voicemail system, the voicemail system transmits the multimedia message to a multimedia messaging service center for delivery of the multimedia message to the electronic device.

According to one embodiment of the voicemail system, the identification information is further added to a multimedia message notification that is associated with the multimedia message.

According to another aspect of the disclosure, a method of preparing a video message for delivery to an electronic device includes storing video data for the video message as part of a multimedia message; and adding identification information to the multimedia message so as to identify the multimedia message as containing video message data, wherein a first portion of the added identification information is content of a subject field of the multimedia message and a second portion of the added identification information is embedded into the multimedia message as one of an extension header or a standardized header.

According to one embodiment of the method, the subject field is scripted so that when the content of the subject field is displayed to a user of the electronic device the user understands that video message data is associated with the displayed content.

According to one embodiment of the method, the multimedia message is transmitted to a multimedia messaging service center for delivery to the electronic device.

According to one embodiment, the method further includes adding the identification information to a multimedia message notification that is associated with the multimedia message.

According to another aspect of the disclosure, a method of processing a multimedia message with an electronic device includes receiving a multimedia message notification associated with the multimedia message and receiving the multimedia message; analyzing at least one of the multimedia message notification or the multimedia message for voicemail message identification information; and if the identification information is detected, associating the multimedia message with a folder dedicated to voicemail messages, otherwise associating the multimedia message with a folder used for general storage of multimedia messages.

According to one embodiment of the method, the added identification information is content of a subject field of the multimedia message that has been scripted so that when the content of the subject field is displayed to a user of the electronic device the user understands that voicemail message data is associated with the displayed content.

According to one embodiment of the method, the added identification information is embedded into the multimedia message as one of an extension header or a standardized header.

According to one embodiment of the method, the multimedia message is generated by a voicemail system and is transmitted to the electronic device by way of a multimedia messaging service center.

According to another aspect of the disclosure, an electronic device configured to process a multimedia message includes a radio transceiver for receiving a multimedia message notification associated with the multimedia message and receiving the multimedia message; a memory for storing the multimedia message; and a control circuit that analyzes at least one of the multimedia message notification or the multimedia message for voicemail message identification information and, if the identification information is detected, the control circuit associates the multimedia message with a folder dedicated to voicemail messages, otherwise the control circuit associates the multimedia message with a folder used for general storage of multimedia messages.

According to one embodiment of the electronic device, the added identification information is content of a subject field of the multimedia message that has been scripted so that when the content of the subject field is displayed to a user of the electronic device the user understands that voicemail message data is associated with the displayed content.

According to one embodiment of the electronic device the added identification information is embedded into the multimedia message as one of an extension header or a standardized header.

According to one embodiment of the method, the multimedia message is generated by a voicemail system and is transmitted to the electronic device by way of a multimedia messaging service center.

These and further features will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the scope of the claims appended hereto.

Features that are described and/or illustrated with respect to one embodiment may be used in the same way or in a similar way in one or more other embodiments and/or in combination with or instead of the features of the other embodiments.

The terms “comprises” and “comprising,” when used in this specification, are taken to specify the presence of stated features, integers, steps or components but do not preclude the presence or addition of one or more other features, integers, steps, components or groups thereof.

### BRIEF DESCRIPTION OF THE DRAWINGS

FIG. 1 is a schematic view of a mobile telephone as an exemplary electronic device that is configured to support an embodiment of visual voicemail;

FIG. 2 is a schematic block diagram of the mobile telephone of FIG. 1; and

FIG. 3 is a schematic diagram of a communications system in which the mobile telephone of FIG. 1 may operate.

### DETAILED DESCRIPTION OF EMBODIMENTS

Embodiments will now be described with reference to the drawings, wherein like reference numerals are used to refer to like elements throughout. It will be understood that the figures are not necessarily to scale.

The interchangeable terms “electronic equipment” and “electronic device” include portable radio communication equipment. The term “portable radio communication equipment,” which hereinafter is referred to as a “mobile radio terminal,” includes all equipment such as mobile telephones, pagers, communicators, electronic organizers, personal digital assistants (PDAs), smartphones, portable communication apparatus or the like.

In the present document, embodiments are described primarily in the context of a mobile telephone. It will be appreciated, however, that the exemplary context of a mobile telephone is not the only context and the context may relate to any type of appropriate electronic equipment, examples of which include a media player, a gaming device and a computer.

In the present document, embodiments are described as placing voicemail message data into a multimedia message (MM). It will be appreciated that the use of a multimedia message is an exemplary embodiment, and other types of messages or data delivery mechanisms may be employed. It will also be appreciated that the payload of the multimedia message may contain data instead of or in addition to audio voicemail data, such as a video message. Therefore, in this section of the disclosure, instances of the phrase “voicemail message” may be replaced with or supplemented with the phrase “video message.”

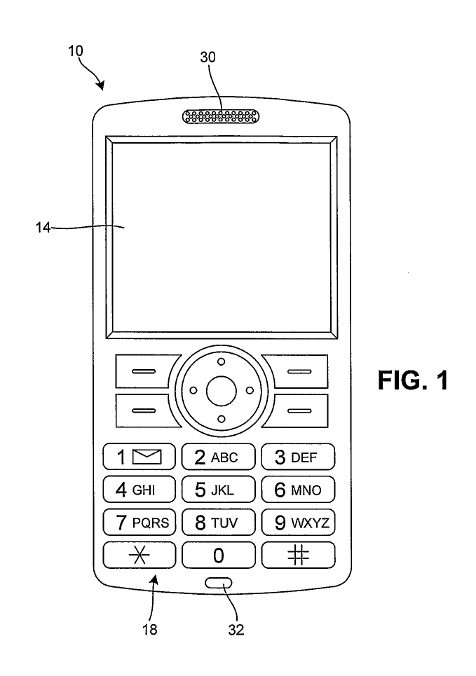

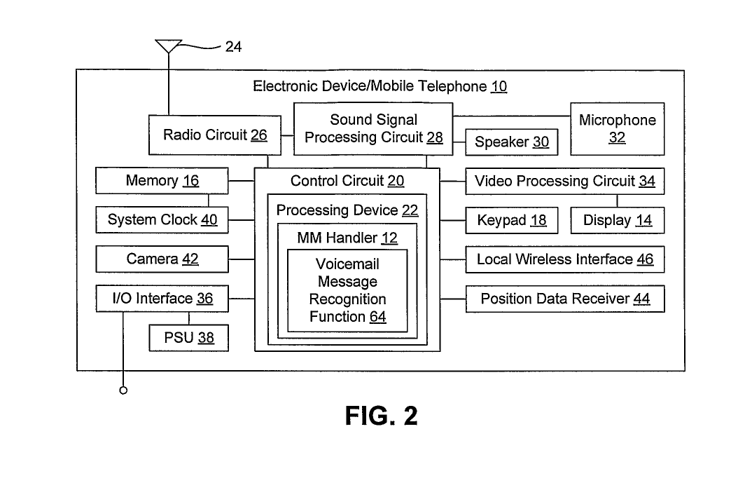

Referring initially to FIGS. 1 and 2, an electronic device is shown. The electronic device 10 includes a multimedia message handler 12 that is configured to accept and process multimedia messages that contain a voicemail message. The voicemail message that is contained in the multimedia message may include audio data corresponding to a recorded voicemail message left by a caller. In the case of a video message, the multimedia message may include video data corresponding to a recorded video message. Also, the voicemail message that is contained in the multimedia message may include additional information, such as data and time of an associated call; identification of the caller (e.g., by telephone number, user or subscriber name, etc.), message importance, audio component duration, a text component that is generated by the caller and so forth.

Additional details and operation of the voicemail features associated with the electronic device 10 will be described in greater detail below. The multimedia message handler 12 and associated functionality to carry out the described features may be embodied as executable code that is resident in and executed by the electronic device 10. In one embodiment, the multimedia message handler 12 may be a program stored on a computer or machine readable medium. The multimedia message handler 12 may be a stand-alone software application or form a part of a software application that carries out additional tasks related to the electronic device 10.

The mobile telephone of the illustrated embodiment is shown as having a “brick” or “block” form factor housing. It will be appreciated that other housing types may be utilized, such as a “flip-open” form factor (e.g., a “clamshell” housing) or a slide-type form factor (e.g., a “slider” housing).

The electronic device 10 may include a display 14. The display 14 displays information to a user such as operating state, time, telephone numbers, contact information, various menus, etc., that enable the user to utilize the various features of the electronic device 10. The display 14 also may be used to visually display content received by the electronic device 10 and/or retrieved from a memory 16 (FIG. 2) of the electronic device 10. The display 14 may be used to present images, video and other graphics to the user, such as photographs, mobile television content and video associated with games. Information associated with received multimedia messages that contain voicemail message data may be displayed on the display as part of a visual voicemail experience.

A keypad 18 provides for a variety of user input operations. For example, the keypad 18 may include alphanumeric keys for allowing entry of alphanumeric information such as telephone numbers, phone lists, contact information, notes, text, etc. In addition, the keypad 18 may include special function keys such as a “call send” key for initiating or answering a call, and a “call end” key for ending or “hanging up” a call. Special function keys also may include menu navigation and select keys to facilitate navigating through a menu displayed on the display 14. For instance, a pointing device and/or navigation keys may be present to accept directional inputs from a user. Special function keys may include audiovisual content playback keys to start, stop and pause playback, skip or repeat tracks, and so forth. Other keys associated with the mobile telephone may include a volume key, an audio mute key, an on/off power key, a web browser launch key, a camera key, etc. Keys or key-like functionality also may be embodied as a touch screen associated with the display 14. Also, the display 14 and keypad 18 may be used in conjunction with one another to implement soft key functionality. These user inputs may be used to navigate through, retrieve and manage displayed voicemail messages.

The electronic device 10 includes call circuitry that enables the electronic device 10 to establish a call and/or exchange signals with a called/calling device, which typically may be another mobile telephone or landline telephone. However, the called/calling device need not be another telephone, but may be some other device such as an Internet web server, content providing server, etc. Calls may take any suitable form. For example, the call could be a conventional call that is established over a cellular circuit-switched network or a voice over Internet Protocol (VoIP) call that is established over a packet-switched capability of a cellular network or over an alternative packet-switched network, such as WiFi (e.g., a network based on the IEEE 802.11 standard), WiMax (e.g., a network based on the IEEE 802.16 standard), etc. Another example includes a video enabled call that is established over a cellular or alternative network.

The electronic device 10 may be configured to transmit, receive and/or process data, such as text messages, instant messages, electronic mail messages, multimedia messages, image files, video files, audio files, ring tones, streaming audio, streaming video, data feeds (including podcasts and really simple syndication (RSS) data feeds), and so forth. It is noted that a text message is commonly referred to by some as “an SMS,” which stands for simple message service or short message service. SMS is a typical standard for exchanging text messages. As used herein, text messages may include formatted text, animations, pictures, icons, sound effects and ring tones as made possible by enhanced message service (EMS), for example. Similarly, a multimedia message is commonly referred to by some as “an MMS,” which stands for multimedia message service. MMS is a typical standard for exchanging multimedia messages. Processing data may include storing the data in the memory 16, executing applications to allow user interaction with the data, displaying video and/or image content associated with the data, outputting audio sounds associated with the data, and so forth.

FIG. 2 represents a functional block diagram of the electronic device 10. For the sake of brevity, many features of the electronic device 10 will not be described in great detail. The electronic device 10 includes a primary control circuit 20 that is configured to carry out overall control of the functions and operations of the electronic device 10. The control circuit 20 may include a processing device 22, such as a central processing unit (CPU), microcontroller or microprocessor. The processing device 22 executes code stored in a memory (not shown) within the control circuit 20 and/or in a separate memory, such as the memory 16, in order to carry out operation of the electronic device 10. In addition, the processing device 22 may execute code that implements the multimedia message handler 12. While the multimedia message handler 12 is executed by the processing device 22 in accordance with an embodiment, such functionality could also be carried out via dedicated hardware or firmware, or some combination of hardware, firmware and/or software.

The memory 16 may be, for example, one or more of a buffer, a flash memory, a hard drive, a removable media, a volatile memory, a non-volatile memory, a random access memory (RAM), or other suitable device. In a typical arrangement, the memory 16 may include a non-volatile memory (e.g., a NAND or NOR architecture flash memory) for long term data storage and a volatile memory that functions as system memory for the control circuit 20. The volatile memory may be a RAM implemented with synchronous dynamic random access memory (SDRAM), for example. The memory 16 may exchange data with the control circuit 20 over a data bus. Accompanying control lines and an address bus between the memory 16 and the control circuit 20 also may be present. Multimedia messages that are received by the electronic device 10, including those that contain voicemail message content, may be stored by the memory 16.

Continuing to refer to FIGS. 1 and 2, the electronic device 10 includes an antenna 24 coupled to a radio circuit 26. The radio circuit 26 includes a radio frequency transmitter and receiver for transmitting and receiving signals via the antenna 24. The radio circuit 26 may be configured to operate in a mobile communications system and may be used to send and receive data and/or audiovisual content. Receiver types for interaction with a mobile radio network and/or broadcasting network include, but are not limited to, global system for mobile communications (GSM), code division multiple access (CDMA), wideband CDMA (WCDMA), general packet radio service (GPRS), WiFi, WiMax, digital video broadcasting-handheld (DVB-H), integrated services digital broadcasting (ISDB), etc., as well as advanced versions of these standards. It will be appreciated that the antenna 24 and the radio circuit 26 may represent one or more than one radio transceiver.

The electronic device 10 further includes a sound signal processing circuit 28 for processing audio signals transmitted by and received from the radio circuit 26. Coupled to the sound processing circuit 28 are a speaker 30 and a microphone 32 that enable a user to listen and speak via the electronic device 10. The radio circuit 26 and sound processing circuit 28 are each coupled to the control circuit 20 so as to carry out overall operation. Audio data may be passed from the control circuit 20 to the sound signal processing circuit 28 for playback to the user. The audio data may include, for example, audio data from an audio file stored by the memory 16 and retrieved by the control circuit 20, or received audio data such as in the form of streaming audio data from a mobile radio service. The sound processing circuit 28 may include any appropriate buffers, decoders, amplifiers and so forth. Audio content representing a recorded voicemail message component of a voicemail and that is contained in a multimedia message may be played back to a user using the circuit 28 and speaker 30. As indicated below, the audio content also may be played back through a personal handsfree accessory or other external speaker.

The display 14 may be coupled to the control circuit 20 by a video processing circuit 34 that converts video data to a video signal used to drive the display 14. The video processing circuit 34 may include any appropriate buffers, decoders, video data processors and so forth. The video data may be generated by the control circuit 20, retrieved from a video file that is stored in the memory 16, derived from an incoming video data stream that is received by the radio circuit 28 or obtained by any other suitable method.

The electronic device 10 may further include one or more I/O interface(s) 36. The I/O interface(s) 36 may be in the form of typical mobile telephone I/O interfaces and may include one or more electrical connectors. As is typical, the I/O interface(s) 36 may be used to couple the electronic device 10 to a battery charger to charge a battery of a power supply unit (PSU) 38 within the electronic device 10. In addition, or in the alternative, the I/O interface(s) 36 may serve to connect the electronic device 10 to a headset assembly (e.g., a personal handsfree (PHF) device) that has a wired interface with the electronic device 10. Further, the I/O interface(s) 36 may serve to connect the electronic device 10 to a personal computer or other device via a data cable for the exchange of data. The electronic device 10 may receive operating power via the I/O interface(s) 36 when connected to a vehicle power adapter or an electricity outlet power adapter. The PSU 38 may supply power to operate the electronic device 10 in the absence of an external power source.

The electronic device 10 also may include a system clock 40 for clocking the various components of the electronic device 10, such as the control circuit 20 and the memory 16.

The electronic device 10 may include a camera 42 for taking digital pictures and/or movies. Image and/or video files corresponding to the pictures and/or movies may be stored in the memory 16.

The electronic device 10 also may include a position data receiver 44, such as a global positioning system (GPS) receiver, Galileo satellite system receiver or the like. The position data receiver 44 may be involved in determining the location of the electronic device 10.

The electronic device 10 also may include a local wireless interface 46, such as an infrared transceiver and/or an RF interface (e.g., a Bluetooth interface), for establishing communication with an accessory, another mobile radio terminal, a computer or another device. For example, the local wireless interface 46 may operatively couple the electronic device 10 to a headset assembly (e.g., a PHF device) in an embodiment where the headset assembly has a corresponding wireless interface.

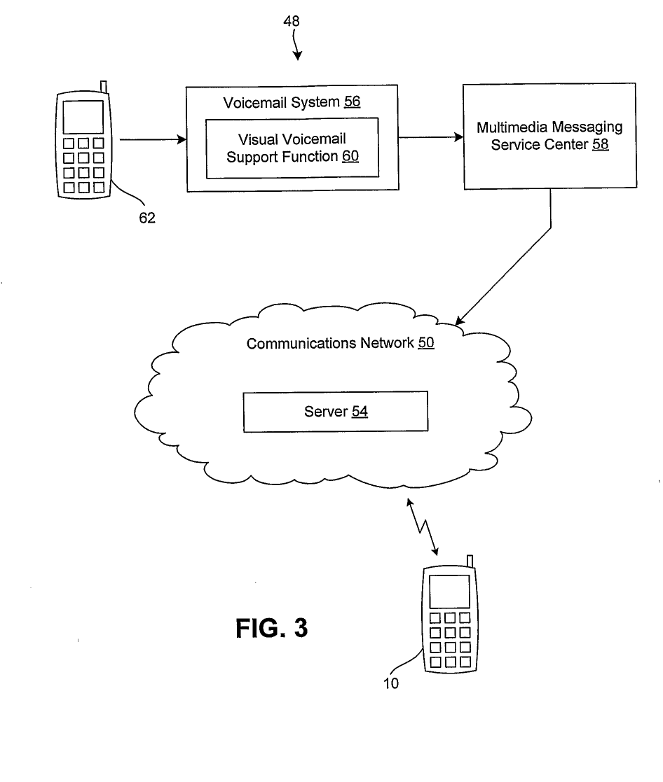

With additional reference to FIG. 3, the electronic device 10 may be configured to operate as part of a communications system 48. The system 48 may include a communications network 50 having a server 54 (or servers) for managing calls placed by and destined to the electronic device 10, transmitting data to the electronic device 10 and carrying out any other support functions. The server 54 communicates with the electronic device 10 via a transmission medium. The transmission medium may be any appropriate device or assembly, including, for example, a communications tower (e.g., a cell tower), another mobile telephone, a wireless access point, a satellite, etc. Portions of the network may include wireless transmission pathways. The network 50 may support the communications activity of multiple mobile telephones 10 and other types of end user devices. As will be appreciated, the server 54 may be configured as a typical computer system used to carry out server functions and may include a processor configured to execute software containing logical instructions that embody the functions of the server 54 and a memory to store such software.

The system 48 may further include a voicemail system 56 and a multimedia message service center (MMSC) 58. The voicemail system 56 and the MMSC 58 may each be implemented using a server or servers that are configured as typical computer systems used to carry out server functions. For instance, these computer systems may include a processor configured to execute software containing logical instructions that embody the functions of the voicemail system 56 and the MMSC 58, respectfully. The voicemail system 56 and the MMSC 58 may be located outside the domain of the communications network 50, as illustrated. Alternatively, the voicemail system 56 and the MMSC 58 may be within the domain of the communications network 50.

In one embodiment, the voicemail system 56 is configured to store and execute a visual voicemail support function 60 that processes voicemail messages as described in greater detail below. In one embodiment, the visual voicemail support function 60 may be a program stored on a computer or machine readable medium. The visual voicemail support function 60 may be a stand-alone software application or may form a part of a software application that carries out additional tasks related to the functions of the voicemail system 56. The functions of the visual voicemail support function 60, the voicemail system 56, and/or the MMSC 58 may be consolidated in a single server (or other host device) or distributed among multiple servers (or other host devices), including the server 54.

A call may be initiated to the electronic device 10 with a calling device 62. The calling device 62 may be another mobile telephone, a land-line telephone, a VoIP device or any other device that is capable of placing a call to the electronic device 10. In most embodiments, the call will be initiated in response to action taken by a user of the calling device 62. If a user of the electronic device 10 does not answer the call or if the electronic device 10 is not available at the time of the call (e.g., is not turned on or not in operative communication with the communication network 50), the call may be forwarded to the voicemail system 56. The voicemail system 56 may prompt the user of the calling device 62 to leave a voicemail message for the user of the electronic device 10. Therefore, a voicemail message for the user of the electronic device 10 may include an audio component generated by the user of the calling device 62 and recorded by the voicemail system 56. The voicemail message may contain additional components, such as an identity of the calling device 62 (e.g., a telephone number associated with the calling device 62, or a name associated with the calling device 62 or the user of the calling device 62). Additional components of the voicemail message may include a flag for the importance of the voicemail message, a text component, a video component, and so forth.

The visual voicemail support function 60 may construct a multimedia message using the content of the voicemail message such that the voicemail message is contained within the multimedia message. For instance, the audio component (or a video component in the case of a video message) may be placed into a payload portion of the multimedia message and caller identification information may be placed in a designated field, such as a header field.

To enable the voicemail message, as contained by the multimedia message, to be processed as a visual voicemail message by the electronic device 10, a subject field of the multimedia message may be populated to contain an indication that the multimedia message is representative of a voicemail message. For instance, a subject field (e.g., a subject header) that reads “voice message” may be used. Also, the same or similar indication may be placed in a subject field (e.g., a subject header) of a corresponding multimedia message notification. A multimedia message notification is sent to the electronic device 10 prior to transmission of the corresponding multimedia message. The multimedia message notification may be generated by the voicemail system 56 or the multimedia messaging service center 58.

By populating subject data in this manner, when a list of multimedia messages are displayed to the user of the electronic device 10 by the contents of the subject field, the user will be able to ascertain that the corresponding item is a voicemail message. In one embodiment, additional information may be placed in the subject field. For instance, the subject field may contain the identification information associated with the calling device 62. In this manner, the visual voicemail support function 60 may script the subject field to read “voice message from XYZ” where “XYZ” is the caller identification information.

Other data may be added to or embedded in the multimedia message by the visual voicemail support function 60 to facilitate treatment of the multimedia message as a voicemail message by the electronic device 10. In one embodiment, an extension header is inserted into the body of the multimedia message and the extension header is populated to indicate that the multimedia message contains voicemail message data. In another embodiment, an existing, standardized multimedia message header may be used to identify the multimedia message as containing voicemail message data by selecting an appropriate header and setting the header in a desired manner. The extension header also may be added to the corresponding multimedia message notification or, if a standardized header issued, the corresponding standardized header of the multimedia message notification may be set with the voicemail message indication.

As will be described in greater detail below, the electronic device 10 may be made “visual voicemail aware” by adding functionality that analyzes the multimedia message and/or the multimedia message notification to recognize the extension header or selected standardized header (or other embedded voicemail identifier) and to treat the multimedia message accordingly. As shown in FIG. 2, this functionality may be a voicemail message recognition function 64 that is made part of the multimedia message handler 12 or is embodied as an add-on software module, for example.

Once the multimedia message containing the voicemail message data is constructed, the multimedia message may be transmitted to the MMSC 58. In one embodiment, the multimedia message may be transmitted over an interface designed to handle multimedia messages that originate from a third party provider. For instance, the interface may be an MM3 interface, an MM4 interface, or an MM7 interface. These interfaces have been defined by the Third Generation Partnership Project (3GPP) in associated standards.

In turn, the MMSC 58 may transmit the multimedia message notification and the corresponding multimedia message to the electronic device 10 as is typical for the delivery of multimedia messages to the electronic device 10. As illustrated, the multimedia message may be delivered by way of the communications network 50.

Upon receipt of the multimedia message notification and/or the multimedia message, the electronic device 10 may process the multimedia message notification and/or the multimedia message. In the embodiment where the electronic device 10 includes the voicemail message recognition function 64 so as to make the electronic device 10 “visual voicemail aware,” the multimedia message handler 12 may recognize the incoming multimedia message as representing a voicemail message. The recognition may be made using the embedded data from the multimedia message notification and/or the multimedia message, which may be information contained in the extension header or in a standardized header, for example. In another embodiment, the recognition may be based on the content of the subject field.

If recognized as containing voicemail message data, the multimedia message may then be distinguished by the electronic device 10 from other multimedia messages that do not contain the embedded information or recognizable subject field content. For instance, the multimedia message may be stored in a folder with other multimedia messages that are recognized as containing voicemail message data. The user may browse this folder to display the contents of the folder, such as in the form of a list of the received multimedia messages or icons corresponding to the multimedia messages. In one embodiment, the contents of the folder may be automatically displayed upon receipt of the multimedia message. The messages associated with the folder may be displayed, for example, by the content of the subject field, date and time and/or another manner upon which information is available. By dedicating this folder to multimedia messages that have been recognized as containing voicemail message data, this folder may be considered a voicemail message inbox. File management techniques may be employed to manage the multimedia messages that are present in the folder including, but not limited to, scrolling through the messages, selecting a message, playing back the voicemail message content contained in a selected multimedia message, deleting a message, forwarding a message to another electronic device, and moving or copying a message to another folder.

Other actions may be carried out upon recognition of a received multimedia message as a multimedia message that contains voicemail message data. For instance, the user may be alerted to the receipt of the message by one or more of outputting an audible sound (e.g., a ring tone), displaying of an icon or graphic, vibrating the electronic device 10, etc.

In one embodiment, the electronic device 10 may not include the voicemail message recognition function 64 or other mechanism to distinguish multimedia messages that contain voicemail message data from other multimedia messages. In this embodiment, the multimedia message may be treated in the manner that any other received multimedia message may be treated. For instance, the multimedia message may be placed in an appropriate folder and the contents of the folder may be displayed in a list or as icons. For instance, the messages associated with the folder may be displayed by the content of the respective subject fields. The user may be able to visually distinguish voicemail messages from other messages by the nomenclature used by the voicemail system 56 to populate the subject field. Also, the user may be able to sort the messages based on the subject field to group together multimedia messages that contain voicemail message data.

The disclosed techniques for delivering voicemail message content to an electronic device as part of a multimedia message and distinguishing the multimedia message as containing such content advantageously makes use of existing features and functionality in many mobile telephones and other electronic devices. Also, there is a reduced need for a dedicated visual voicemail client that is executed by the electronic device as any MMS capable device may be able to access the disclosed visual voicemail techniques. Furthermore, using a multimedia message platform to deliver voicemail message content easily allows for the addition of image, video and other content types to the voicemail message content without upgrading or reconfiguring the electronic device. Also, the content adaptation features in the MMS infrastructure may be used.

Although certain embodiments have been shown and described, it is understood that equivalents and modifications falling within the scope of the appended claims will occur to others who are skilled in the art upon the reading and understanding of this specification.

1. A method of preparing a voicemail message for delivery to an electronic device, comprising:
storing audio data from a user of a calling device as part of a multimedia message; and
adding identification information to the multimedia message so as to identify the multimedia message as containing voicemail message data, wherein a first portion of the added identification information is content of a subject field of the multimedia message and a second portion of the added identification information is embedded into the multimedia message as one of an extension header or a standardized header, the second portion of the added identification information embedded in a predetermined manner so that, upon receipt of the multimedia message by the electronic device, a multimedia message handler of the electronic device recognizes the multimedia message as representing a voicemail message and stores the multimedia message in a voicemail message folder with other multimedia messages that are recognized as containing voicemail message data.

2. The method of claim 1, wherein the subject field is scripted so that when the content of the subject field is displayed to a user of the electronic device the user understands that voicemail message data is associated with the displayed content.

3. The method of claim 1, wherein the multimedia message is transmitted to a multimedia messaging service center for delivery to the electronic device.

4. The method of claim 1, further comprising adding the identification information to a multimedia message notification that is associated with the multimedia message.

5. A voicemail system that prepares a voicemail message for delivery to an electronic device, the voicemail system comprising a visual voicemail support function that stores audio data from a user of a calling device as part of a multimedia message and adds identification information to the multimedia message so as to identify the multimedia message as containing voicemail message data, wherein a first portion of the added identification information is content of a subject field of the multimedia message and a second portion of the added identification information is embedded into the multimedia message as one of an extension header or a standardized header, the second portion of the added identification information embedded in a predetermined manner so that, upon receipt of the multimedia message by the electronic device, a multimedia message handler of the electronic device recognizes the multimedia message as representing a voicemail message and stores the multimedia message in a voicemail message folder with other multimedia messages that are recognized as containing voicemail message data.

6. The voicemail system of claim 5, wherein the subject field is scripted so that when the content of the subject field is displayed to a user of the electronic device the user understands that voicemail message data is associated with the displayed content.

7. The voicemail system of claim 5, wherein the voicemail system transmits the multimedia message to a multimedia messaging service center for delivery of the multimedia message to the electronic device.

8. The voicemail system of claim 5, wherein the identification information is further added to a multimedia message notification that is associated with the multimedia message.

9. A method of preparing a video message for delivery to an electronic device, comprising:
storing video data for the video message as part of a multimedia message; and
adding identification information to the multimedia message so as to identify the multimedia message as containing video message data, wherein a first portion of the added identification information is content of a subject field of the multimedia message and a second portion of the added identification information is embedded into the multimedia message as one of an extension header or a standardized header, the second portion of the added identification information embedded in a predetermined manner so that, upon receipt of the multimedia message by the electronic device, a multimedia message handler of the electronic device recognizes the multimedia message as representing a videomail message and stores the multimedia message in a videomail message folder with other multimedia messages that are recognized as containing videomail message data.

10. The method of claim 9, wherein the subject field is scripted so that when the content of the subject field is displayed to a user of the electronic device the user understands that video message data is associated with the displayed content.

11. The method of claim 9, wherein the multimedia message is transmitted to a multimedia messaging service center for delivery to the electronic device.

12. The method of claim 9, further comprising adding the identification information to a multimedia message notification that is associated with the multimedia message.

13. A method of processing a multimedia message with an electronic device, comprising:
receiving a multimedia message notification associated with the multimedia message and receiving the multimedia message;
upon receipt of the multimedia message notification or the multimedia message, a multimedia message handler of the electronic device analyzing at least one of the multimedia message notification or the multimedia message for voicemail message identification information; and
if the identification information is detected, the multimedia message handler recognizing the multimedia message as representing a voicemail message and associating the multimedia message with a folder dedicated to voicemail messages, otherwise associating the multimedia message with a folder used for general storage of multimedia messages.

14. The method of claim 13, wherein the added identification information is content of a subject field of the multimedia message that has been scripted so that when the content of the subject field is displayed to a user of the electronic device the user understands that voicemail message data is associated with the displayed content.

15. The method of claim 13, wherein the added identification information is embedded into the multimedia message as one of an extension header or a standardized header.

16. The method of claim 13, wherein the multimedia message is generated by a voicemail system and is transmitted to the electronic device by way of a multimedia messaging service center.

17. An electronic device configured to process a multimedia message, comprising:
a radio transceiver for receiving a multimedia message notification associated with the multimedia message and receiving the multimedia message;
a memory for storing the multimedia message; and
a control circuit that, upon receipt of the multimedia message notification or the multimedia message, analyzes at least one of the multimedia message notification or the multimedia message for voicemail message identification information and, if the identification information is detected, the control circuit recognizes the multimedia message as representing a voicemail message and associates the multimedia message with a folder dedicated to voicemail messages, otherwise the control circuit associates the multimedia message with a folder used for general storage of multimedia messages.

18. The electronic device of claim 17, wherein the added identification information is content of a subject field of the multimedia message that has been scripted so that when the content of the subject field is displayed to a user of the electronic device the user understands that voicemail message data is associated with the displayed content.

19. The electronic device of claim 17, wherein the added identification information is embedded into the multimedia message as one of an extension header or a standardized header.

20. The electronic device of claim 17, wherein the multimedia message is generated by a voicemail system and is transmitted to the electronic device by way of a multimedia messaging service center.
